(19) United States
(12) Patent Application Publication
(10) Pub. No.: US 2013/0064138 A1
(43) Pub. Date: Mar. 14, 2013

(54) Mechanism for controlling device-to-device discovery procedcure

(71) Applicants: Sami-Jukka Hakola, Kempele (FI); Timo Koskela, Oulu (FI); Samuli Turtinen, Ii (FI)

(72) Inventors: Sami-Jukka Hakola, Kempele (FI); Timo Koskela, Oulu (FI); Samuli Turtinen, Ii (FI)

(73) Assignee: Renesas Mobile Corporation, Tokyo (JP)

(21) Appl. No.: 13/199,945

(22) Filed: Sep. 12, 2011

(51) Int. Cl. H04L 12/28

(52) U.S. Cl. 370/255

(57) ABSTRACT

There is provided a mechanism for registering and attaching a UE to a D2D discovery function. After identifying an ID information of at least one PLMN assigned for a D2D discovery and communication, a request for registering and attaching the UE to the D2D discovery function at the identified PLNM is sent to the network. The network sends a grant for the D2D discovery together with an indication corresponding to an identity of the at least one PLMN used for communicating resources dedicated to the D2D discovery and communication.

### BACKGROUND OF THE INVENTION

### Field of the Invention

The present invention relates to a mechanism usable for controlling a discovery and communication between communication devices in a device-to-device way. In particular, the present invention is related to apparatuses, methods and computer program products providing a mechanism by means of which devices wishing to conduct a device-to-device communication can discover each other and start to establish a device-to-device communication.

The following meanings for the abbreviations used in this specification apply:
BS: base station
CCCH: common control channel
D2D: device-to-device
DCCH: dedicated control channel
DL: downlink
EMM: EPS mobility management
eNB: enhanced node B
EPC: evolved packet core
EPS: evolved packet system
EUTRAN: evolved universal terrestrial radio access network
ID: identification
LTE: Long Term Evolution
LTE-A: LTE Advanced
MAC: medium access control
MME: mobility management entity
PDCCH: physical download control channel
PLMN: public land mobile network
RB: radio bearer
RNTI: radio network temporary identifier
RRC: radio resource control
SIB: system information block
SRB: signaling radio bearer
UE: user equipment
UL: uplink

In the last years, an increasing extension of communication networks, e.g. of wire based communication networks, such as the Integrated Services Digital Network (ISDN), DSL, or wireless communication networks, such as the cdma2000 (code division multiple access) system, cellular 3rd generation (3G) communication networks like the Universal Mobile Telecommunications System (UMTS), enhanced communication networks based e.g. on LTE, cellular 2nd generation (2G) communication networks like the Global System for Mobile communications (GSM), the General Packet Radio System (GPRS), the Enhanced Data Rates for Global Evolutions (EDGE), or other wireless communication system, such as the Wireless Local Area Network (WLAN), Bluetooth or Worldwide Interoperability for Microwave Access (WiMAX), took place all over the world. Various organizations, such as the 3rd Generation Partnership Project (3GPP), Telecoms & Internet converged Services & Protocols for Advanced Networks (TISPAN), the International Telecommunication Union (ITU), 3rd Generation Partnership Project 2 (3GPP2), Internet Engineering Task Force (IETF), the IEEE (Institute of Electrical and Electronics Engineers), the WiMAX Forum and the like are working on standards for telecommunication network and access environments.

Recently, so-called “proximity-based” applications and services came into the focus of further developments in the field of telecommunications. The term proximity-based applications and services may be used, for example, in cases where two or more devices (i.e. two or more users), which are close to each other, are interested in exchanging data, if possible, directly with each other. Currently, such “proximity-based” applications operate fully “over the top” and are based on “high-level software”, typically relying on a mix of GPS location and of the 3GPP mobile systems used as “data pipes”.

However, such an approach presents fundamental technology limitations from the point of view of e.g. device battery life (due to the extensive GPS usage), signaling load to the network (due to the required uplink bursty traffic) and simplicity (due to the “proactive” behavior required of the user, e.g. the “check in”).

While the use of an unlicensed-spectrum communication can address some of the aspects mentioned earlier, it still presents some limitations. For example, discovery processes are being defined based on direct message exchanges and thus not optimal for operation over longer ranges (hundreds of meters or more), or preserve a reasonable battery life. For the same reason, an unlicensed option cannot be expected to scale among a large number of devices.

For future cellular communication networks, a possible method for such proximity-based applications and services is the so-called device-to-device (D2D) communication. D2D offers a high communication speed, large capacity and a high quality of service which are important features to be achieved. Advantages achievable by the implementation of D2D communications in the cellular communication environment are, for example, an offloading of the cellular system, reduced battery consumption due to lower transmission power, an increased data rate, an improvement in local area coverage robustness to infrastructure failures and also an enablement of new services. This is possible while also providing access to licensed spectrum with a controlled interference environment to avoid the uncertainties of license exempt band. Due to this, D2D communication gains more and more attraction and interest.

However, in order to make a D2D discovery and communication applicable to communication networks, such as those based on 3GPP LTE systems, it is necessary to evolve a suitable platform in order to intercept the demand of proximity-based applications so that it is possible that devices, such as UEs or the like, can discover each other directly over the air, and potentially communicate directly, wherein a certain level of control for the network operator side has to be maintained so that D2D communication makes sense from a system management point of view.

### SUMMARY OF THE INVENTION

It is an object of the invention to provide an apparatus, method and computer program product by means of which an improved mechanism usable for controlling a D2D discovery and communication between devices such as UEs is provided. In particular, it is an object of the present invention to provide a mechanism by means of which a scalable solution for a radio-based discovery among any devices can be provided, i.e. by means of which resources for the devices for D2D discovery can be provided, wherein the D2D discovery is also suitable to work across different operators, i.e. different communication networks.

This object is achieved by the measures defined in the attached claims.

According to an example of an embodiment of the proposed solution, there is provided, for example, an apparatus comprising an identification processing portion configured to receive and identify an identification information of at least one communication network assigned for a device-to-device discovery and communication, a request processing portion configured to send a request for registering and attaching a communication network element to a device-to-device discovery function at the at least one communication network assigned for the device-to-device discovery and communication, and a response processing portion configured to receive and process a message indicating a grant for the device-to-device discovery, the message comprising an indication corresponding to an identity of the at least one communication network used for communicating resources dedicated to the device-to-device discovery and communication. Furthermore, according to an example of an embodiment of the proposed solution, there is provided, for example, a method comprising receiving and identifying an identification information of at least one communication network assigned for a device-to-device discovery and communication, sending a request for registering and attaching a communication network element to a device-to-device discovery function at the at least one communication network assigned for the device-to-device discovery and communication, and receiving and processing a message indicating a grant for the device-to-device discovery, the message comprising an indication corresponding to an identity of the at least one communication network used for communicating resources dedicated to the device-to-device discovery and communication.

According to a further example of an embodiment of the proposed solution, there is provided, for example, an apparatus comprising an identification transmission portion configured to send an identification information of at least one communication network assigned for a device-to-device discovery and communication, a request receiving portion configured to receive and process a request for registering and attaching a communication network element to a device-to-device discovery function at the at least one communication network assigned for the device-to-device discovery and communication, and a granting processing portion configured to decide on a grant for the device-to-device discovery and to send a message indicating the grant for the device-to-device discovery, the message comprising an indication corresponding to an identity of the at least one communication network used for communicating resources dedicated to the device-to-device discovery and communication.

Furthermore, according to the further example of an embodiment of the proposed solution, there is provided, for example, a method comprising sending an identification information of at least one communication network assigned for a device-to-device discovery and communication, receiving and processing a request for registering and attaching a communication network element to a device-to-device discovery function at the at least one communication network assigned for the device-to-device discovery and communication, and deciding on a grant for the device-to-device discovery and sending a message indicating the grant for the device-to-device discovery, the message comprising an indication corresponding to an identity of the at least one communication network used for communicating resources dedicated to the device-to-device discovery and communication.

In addition, according to examples of the proposed solution, there is provided, for example, a computer program product for a computer, comprising software code portions for performing the steps of the above defined methods, when said product is run on the computer. The computer program product may comprise a computer-readable medium on which said software code portions are stored. Furthermore, the computer program product may be directly loadable into the internal memory of the computer and/or transmittable via a network by means of at least one of upload, download and push procedures.

By virtue of the proposed solutions, it is possible to provide a mechanism usable for controlling a D2D discovery and communication between devices, that allows devices to conduct a discovery procedure so as to discover each other directly, e.g. over the air, and to potentially communicate directly with each other wherein an appropriate network supervision is ensured. The proposed mechanism allows also that network operators retain control of the device behavior, i.e. they can control when, where and by whom discovery signals are emitted, which devices are allowed to react to the discovery signals, and the like. Furthermore, there are provided means so that a device like a UE wishing to conduct a D2D communication can conduct a registration for a D2D discovery function wherein also required authentication and security functions can be supported. Furthermore, the proposed mechanism is applicable to D2D discovery processes between devices belonging to different operators, i.e. different communication networks.

The above and still further objects, features and advantages of the invention will become more apparent upon referring to the description and the accompanying drawings.

### BRIEF DESCRIPTION OF THE DRAWINGS

FIG. 1 shows a flow chart illustrating a procedure conducted by a communication network element for registering in a D2D discovery function according to examples of embodiments of the invention.

FIG. 2 shows a flow chart illustrating a procedure conducted by a communication network control element for registering a communication network element in a D2D discovery function according to examples of embodiments of the invention.

FIG. 3 shows a signaling diagram illustrating a procedure for registering a communication network element in a D2D discovery function according to further examples of embodiments of the invention.

FIG. 4 shows a signaling diagram illustrating a procedure for registering a communication network element in a D2D discovery function according to still further examples of embodiments of the invention.

FIG. 5 shows a block circuit diagram of a communication network control element including processing portions conducting functions according to examples of embodiments of the invention.

FIG. 6 shows a block circuit diagram of a communication network element including processing portions conducting functions according to examples of embodiments of the invention.

### DESCRIPTION OF PREFERRED EMBODIMENTS

In the following, examples and embodiments of the present invention are described with reference to the drawings. For illustrating the present invention, the examples and embodiments will be described in connection with a cellular communication network based on a 3GPP LTE system. However, it is to be noted that the present invention is not limited to an application using such types of communication system, but is also applicable in other types of communication systems and the like.

A basic system architecture of a communication system where examples of embodiments of the invention are applicable may comprise a commonly known architecture of one or more communication networks comprising a wired or wireless access network subsystem and a core network. Such an architecture may comprise one or more access network control elements, radio access network elements, access service network gateways or base transceiver stations, such as a base station (BS) or eNB, with which a communication network element or device such as a UE or another device having a similar function, such as a modem chipset, a chip, a module etc., which can also be part of a UE or attached as a separate element to a UE, or the like, is capable to communicate via one or more channels for transmitting several types of data. Furthermore, core network elements such as gateway network elements, policy and charging control network elements, mobility management entities and the like may be comprised.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication connection to or from UEs or eNBs, besides those described in detail herein below.

Furthermore, the described network elements, such as communication network elements like UEs or communication network control elements like BSs or eNBs, and the like, as well as corresponding functions as described herein may be implemented by software, e.g. by a computer program product for a computer, and/or by hardware. In any case, for executing their respective functions, correspondingly used devices, nodes or network elements may comprise several means and components (not shown) which are required for control, processing and communication/signaling functionality. Such means may comprise, for example, one or more processor units including one or more processing portions for executing instructions, programs and for processing data, memory means for storing instructions, programs and data, for serving as a work area of the processor or processing portion and the like (e.g. ROM, RAM, EEPROM, and the like), input means for inputting data and instructions by software (e.g. floppy diskette, CD-ROM, EEPROM, and the like), user interface means for providing monitor and manipulation possibilities to a user (e.g. a screen, a keyboard and the like), interface means for establishing links and/or connections under the control of the processor unit or portion (e.g. wired and wireless interface means, an antenna, etc.) and the like. It is to be noted that in the present specification processing portions should not be only considered to represent physical portions of one or more processors, but may also be considered as a logical division of the referred processing tasks performed by one or more processors.

One feature to future communication systems is to provide a support for radio access network sharing. That is, service providers are enabled to reduce the cost of owning and operating the network by allowing the service providers to have a separate core network structure (e.g. with mobility management, gateway nodes etc.) while the radio access network (e.g. EUTRAN with eNBs) is jointly shared by them. For example, in LTE-based system, this may be based on supporting a multi-to-multi relationship between EUTRAN nodes (i.e. eNBs) and EPC nodes (such as mobility management entities) by means of the so-called S1-flex concept. In the S1-flex concept, each eNB may be connected to multiple CN entities. When a UE attaches to the network, it is connected to the appropriate CN entities, for example based on the identity of the service provider selected and sent by the UE.

In case the radio access network, such as the E-UTRAN, is shared by multiple operators, it is necessary to inform devices such as UEs located in the cell covered by the respective eNB or the like about the operators or PLMNs available for communication. This information may be conducted, for example, by sending or broadcasting system information in the shared cell which contains identification information of the operators/PLMNs, e.g. an information containing the PLMN-id of each operator, and a single tracking area code (TAC) or the like which is valid within all the PLMNs sharing the radio access network resources (i.e. the respective eNB). There may be certain limits for the number of operators/PLMNs allowed to share one eNB or the like (in the case of an LTE based network, up to 6).

When receiving the system information, e.g. in the form of a SIB (SIB1 in case of LTE), a receiving device such as a UE is able to read the different PLMN-ids, to select one of the PLMN-ids at an initial attachment and to indicate this PLMN-id to the E-UTRAN in subsequent instances after an initial access (e.g. after conducting a random access procedure to connect to the EUTRAN, or the like). On the other hand, when receiving the selection of UE regarding the PLMN, the E-UTRAN (i.e. the eNB) selects an appropriate mobility management node (e.g. an MME) allocated to the PLMN indicated by the UE. Once attached to an MME, the UE is able to indicate the allocated MME in subsequent instances.

According to examples of embodiments of the invention, for enabling D2D communication, it is assumed that at least one specific PLMN ID is assigned for the D2D discovery and communication that can be used by devices (UEs) belonging to the different operators in a shared manner under supervision of the network.

For example, the radio access network, e.g. the eNB, that supports the D2D discovery and communication under its controlled radio resources transmits, for example in connection with the transmission of the system information, an information element which identifies the PLMN which is assigned for the D2D discovery and communication. In other words, according to a specific example, in case an eNB supports D2D communication in a manner as defined in examples of embodiments of the invention, and when this feature is enabled, the eNB transmits in connection with the SIB1 an identification of a PLMN, i.e. a PLMN ID, which is assigned for that purpose.

According to one example of embodiments of the invention, the ID information of the PLMN assigned for the D2D discovery is transmitted in the system information (e.g. in SIB1) signaling in a PLMN identity list. When a specific number of PLMNs allowed to share the radio access network is given (e.g. six different PLMNs in case of LTE), then the ID information of one or more PLMNs assigned for D2D discovery and communication Ids may be added to this “normal” list. For example, in case six different operators are usually supported per one cell, a conventional list may have the form like:
PLMN−IdentityList=SEQUENCE (SIZE (1..6)) OF PLMN-IdentityInfo.

For indicating the IDs of the PLMN assigned for the D2D discovery and communication across the existing six operators, this list is supplemented with additional indices 7, 8 . . . so as to have e.g. a form like
PLMN-IdentityList=SEQUENCE (SIZE (1..8)) OF PLMN-Identitylnfo.

That is, the PLMNs assigned for the D2D discovery and communication purposes across operators are allocated to the new indices 7, 8, . . . . Thus, the UE may select a corresponding PLMN for D2D communication from one of the PLMNs assigned to indices 7, 8, etc.

According to a further example of embodiments of the invention, instead of using the above described supplement to a PLMN list, a separate data field may be added to the system information in order to indicate ID information of PLMNs assigned to the D2D discovery and communication. While in the above described example, by the addition of further indices to an existing and established list, the size of the PLMN identity list is increased and backward compatibility issues may be caused in the system information transmission and reception, the present example of embodiments can overcome such issued.

Specifically, according to the present example, the ID information of the PLMN(s) assigned for the D2D discovery and communication is added to the PLMN info (e.g. the SIB1) in a data field specified for this purpose. In the following, the PLMN indicated in the information may be also referred to as shared PLMN, which is indicated as a new field e.g. at the end of a SIB1 type element. When receiving system information with such a data field, a receiving UE, when being able to support D2D communication, is configurable to read and interpret the information contained in this new data field, while a UE or device being not able to support a D2D communication and thus not being able to interpret this data field may ignore it.

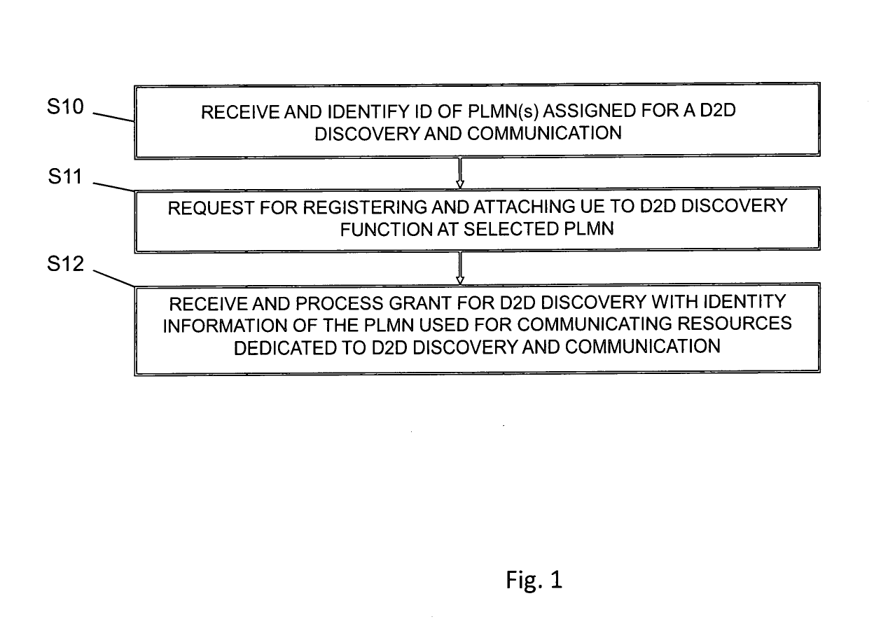

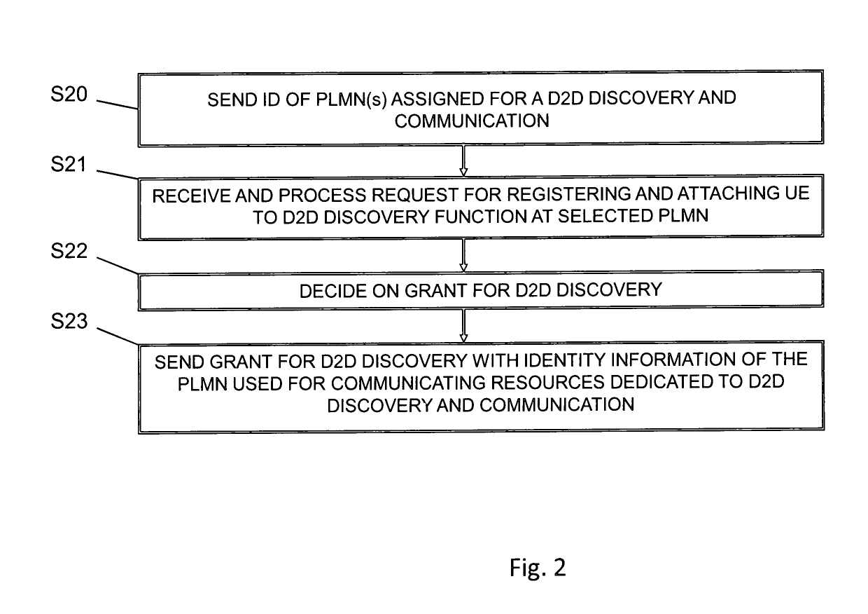

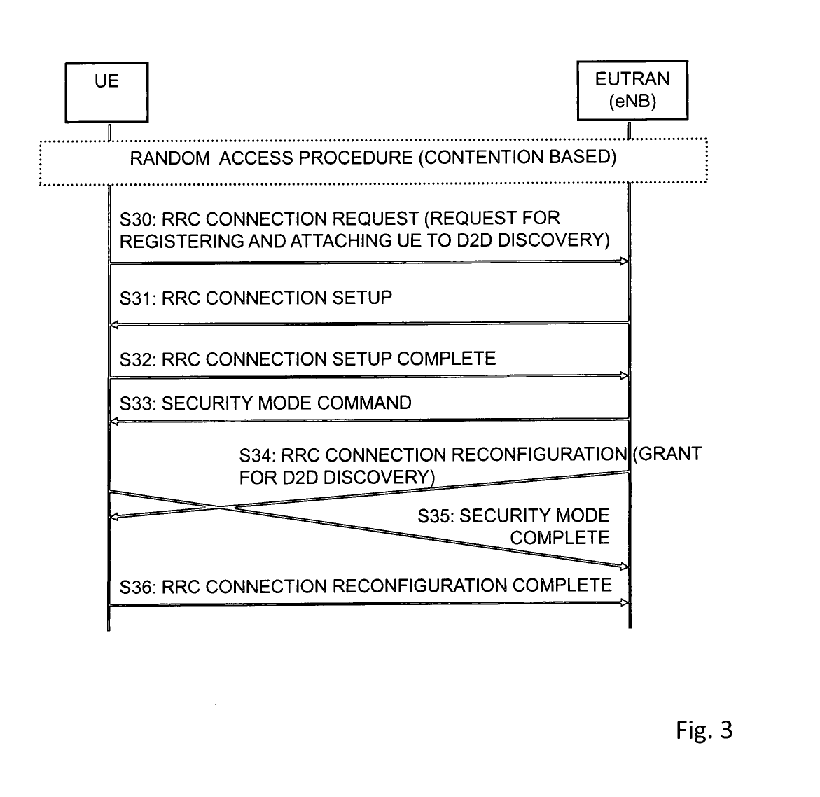

In the following, further examples of embodiments of the invention are described below with regard to FIGS. 1 and 2. Specifically, FIG. 1 shows a flowchart illustrating a processing executed by a communication network element like a UE in a D2D discovery function registration procedure according to examples of embodiments of the invention. FIG. 3 shows a flowchart illustrating a processing executed by a communication network control element like a BS or eNB (i.e. EUTRAN element) in a D2D discovery function registration procedure for a UE according to examples of embodiments of the invention.

According to FIG. 1, in step S10, a communication network element, such as a UE or the like, receives and identifies an ID information of at least one communication network (i.e. PLMN) assigned for a D2D discovery and communication. The ID information may be received in a system information transmitted from a eNB or the like, such as indicated above, in connection with a SIB1 transmission or the like.

When the UE has identified the PLMN(s) which are assigned for a D2D discovery and communication (i.e. PLMN(s) which provide resources usable by devices for discovering and communicating with each other in a D2D way), and decides to start a D2D discovery, the UE initiates a registration and attachment to the D2D function provided by the eNB, for example. For this purpose, in step S11, the UE sends a request for registering and attaching the UE to the D2D discovery function at at least one of the PLMN(s) indicated in the system information as shared PLMN.

Then, in step S13, the UE receives a grant for the D2D discovery, i.e. a message which includes an indicated that the UE is allowed (registered) to use resources of the shared PLMN for conducting a D2D discovery and communication with other devices. In this connection, the UE processes the content of the grant message which comprises, for example, an indication corresponding to an identity of the PLMN used for communicating resources dedicated to the D2D discovery and communication, such as a radio network temporary identity allocated to the shared PLMN that is used to detect dynamic resource allocation messages from the eNB for the D2D discovery, for example.

On the other hand, on the access network side, e.g. the EUTRAN (eNB), the steps described in connection with FIG. 2 are conducted in the D2D registration and attachment procedure for a UE.

Specifically, in step S20, the ID information of the at least one PLMN (shared PLMN) assigned for the D2D discovery and communication is sent (e.g. broadcasted with system information, or the like), as described above.

Then, in step S21, a request for registering and attaching a communication network element, such as a UE, to a D2D device discovery function at the at least one shared PLMN is received (in accordance with step S11 of FIG. 1). The request is processed, e.g. in order to detect whether the requesting UE is allowed to participate in the D2D discovery function, which PLMN (if more than one is present) is related, etc.

Then, in step S22, the eNB decides on the grant for the D2D discovery participation of the requesting UE. If access to the D2D discovery is granted, the eNB sends in step S23 a corresponding grant message to the requesting UE, together with an indication corresponding to an identity of the PLMN used for communicating resources dedicated to the D2D discovery and communication, such as a radio network temporary identity allocated to the shared PLMN that is used to detect dynamic resource allocation messages from the eNB for the D2D discovery, for example.

Even though not shown in FIG. 2, in case the decision on the grant in step S22 is negative, the processing may be ended and/or the requesting UE may be notified correspondingly.

Next, a first implementation example of the D2D registration and attachment procedure described in connection with FIGS. 1 and 2 is described.

In the present example, it is assumed that a device (UE) aims to start a D2D discovery and communication. Thus, the device sends a request message, for example a new type of RRC message, to the eNB in which it indicates the selected PLMN which is the shared PLMN. The new RRC message may be transmitted upon completing an initial access to the eNB, e.g. upon a random access procedure. The eNB then responds also with reply message, such as a corresponding new RRC message, in order to transmit the grant for the D2D discovery and communication. This message comprises also, for example, a common RNTI that is used to detect dynamic resource allocation messages from the eNB for D2D discovery purposes.

In the following, a second implementation example of embodiments of the invention is described in connection with FIG. 3, which shows a signaling diagram between a communication network element (such as a UE) and a communication network control element (such as a EUTRAN element like a eNB). In the example according to FIG. 3, in contrast to the above described first implementation example, also an authentication of the device can be considered.

FIG. 3 shows an example which is based on an RRC connection establishment procedure built upon a random access procedure in an LTE system. That is, according to the present example, a connection establishment procedure, such as an RRC connection establishment procedure in LTE, is modified so as to be usable for a D2D discovery function registration and attachment according to examples of embodiments of the invention, wherein also support for authentication of the devices is provided by the network.

Specifically, according to the example shown in FIG. 3, it is assumed that a UE is in an idle operation mode, such as an RRC_IDLE mode. When it is decided at the UE side (for example by signaling from higher layers or by a user input) that a D2D communication is desired, which requires also a discovery of a corresponding partner node via a supporting network, the UE starts a registration/attachment procedure for participating on the D2D discovery function.

In detail, after a random access procedure is conducted, and the UE has detected the ID information of one or more shared PLMN(s) from the SIB1, when the D2D discovery is to be enabled, the UE sends in step S30 a new RRC Connection Request for establishing an RRC connection. In the request message may comprise as an indication that a registration and attachment to the D2D discovery function is desired a new type of establishment cause code or the like. For example, the message may include a cause indicating the D2D discovery in RRCConnectionRequest message, which may be implemented, for example, as an additional cause besides existing causes in a form like:

EstablishmentCause=ENUMERATED{emergency, highPriorityAccess, mt-Access, mo-Signalling, mo-Data, delayTolerantAccess-v10x0, d2dDiscovery, spare1}

wherein “emergency”, “highPriorityAccess”, “mt-Access”, “mo-Signalling”, “mo-Data”, “delayTolerantAccess-v10x0” and “spare1” are existing causes and d2dDiscovery represent the new cause.

When detecting the cause d2dDiscovery, the eNB responds in step S31 with a connection setup message. For example, the eNB sends to the UE a RRCConnectionSetup message with minimum content which suffices just to setup signaling radio bearer (e.g. SRB1) connection for the following signaling.

In step S32, upon receiving the RRCConnectionSetup message, the UE which has initiated the procedure send a connection setup completion message, such as RRCConnectionSetupComplete message, for establishing the beared connection. For the setup completion message, the UE considers that the PLMN identity indicated therein corresponds to the shared PLMN identity.

Furthermore, as in RRC_IDLE state the UE is registered to a MME, a corresponding indication (i.e. MME registered field, or the like) may be included from which the eNB/network can derive the PLMN to which the UE actually belongs. Thus, a related authentication procedure can be conducted with the correct operator.

Thus, in steps S33 and S35, a normal initial authentication and security activation may be conducted via an exchange of security mode command messages between the UE and the EUTRAN, e.g. via SRB1 connection. This authentication and security activation may be executed in a common manner and is thus not described in further detail.

In parallel to or after the authentication and security activation in steps S33 and S35, the eNB sends in step S34 a connection reconfiguration message which represents also the grant for the D2D discovery. The message in step S34, which may be a RRCConnectionReconfiguration message includes, for example, a newUE-Identity corresponding to the common RNTI that is used by joined devices to receive radio resource allocations for the D2D discovery and communication, e.g. via PDCCH, from the shared PLMN. This message represents the grant for the D2D discovery.

According to further examples, the message in step S35 may also include a timer value or the like which is used for indicating how long the current registration to the D2D discovery (and/or communication) may last. That is, the time value may be used by the UE (and the eNB) for an implicit release of registration of the UE to the D2D discovery function.

Upon receiving the RRCConnectionReconfiguration message, the device responses in step S36 with a corresponding complete message, such as an RRCConnectionReconfigurationComplete message, which completes the message exchange of this procedure.

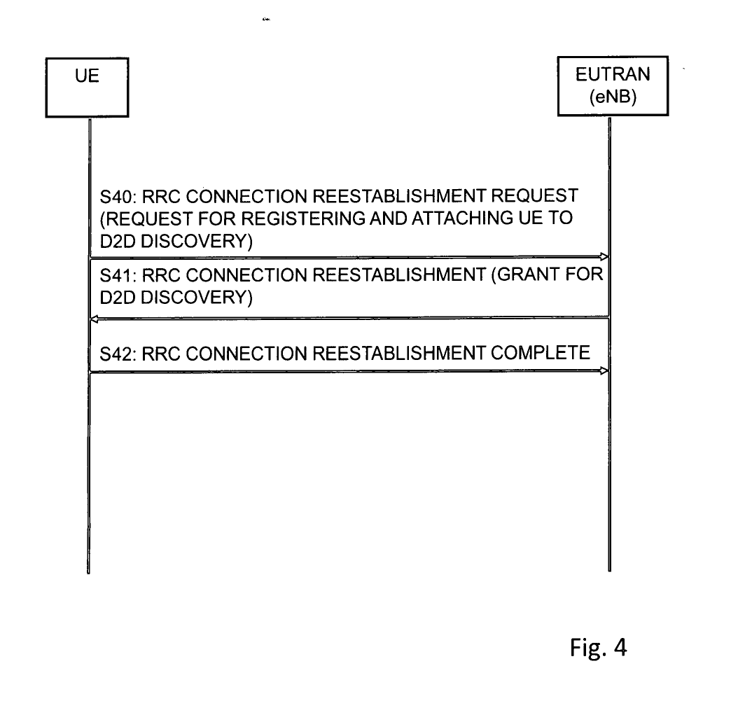

In the following, a third implementation example of embodiments of the invention is described in connection with FIG. 4, which shows a signaling diagram between a communication network element (such as a UE) and a communication network control element (such as a EUTRAN element like a eNB).

FIG. 4 shows an example which is based on an RRC connection re-establishment procedure in an LTE system. That is, according to the present example, a connection re-establishment procedure, such as an RRC connection re-establishment procedure in LTE, is modified so as to be usable for a D2D discovery function registration and attachment according to examples of embodiments of the invention.

Specifically, according to the example shown in FIG. 4, it is assumed that a UE is in an connected operation mode, such as an RRC_CONNECTED mode. When it is decided at the UE side (for example by signaling from higher layers or by a user input) that a D2D communication is desired, which requires also a discovery of a corresponding partner node via a supporting network, the UE starts a registration/attachment procedure for participating on the D2D discovery function. In this case, an initial authentication and security activation can be omitted.

In step S40, the UE sends a reestablishment request, such as a RRCConnectionReestablishmentRequest message, to the eNB wherein, as an indication that a registration and attachment to the D2D discovery function is desired a new type of reestablishment cause code or the like is included. For example, the message may include a cause indicating the D2D discovery in the RRCConnectionRestablishmentRequest message, which may be implemented, for example, as an additional cause besides existing causes in a form like:
ReestablishmentCause=ENUMERATED{reconfigurationFailure, handoverFailure, otherFailure, d2dDiscovery}
   wherein “reconfigurationFailure”, “handoverFailure” and “otherFailure” are existing causes and “d2dDiscovery” represent the new cause.

According to further examples, the reestablishment message may be sent via different ways to the eNB. For example, a common control channel may be used with a corresponding SRB, such as CCCH/SRB0. Alternatively, the message may be also sent on a dedicated control channel with a corresponding signaling bearer, such as DCCH/SRB2 without contention. Furthermore, it is to be noted that with the present implementation example the UE is not required to suspend other radio bearers (RBs), to reset MAC, or to release any current resources.

Furthermore, according to examples of embodiments of the invention, which can be used in this third implementation example according to FIG. 4, the selected shared PLMN may be added as a new field into the re-establishment request message, for example in case there is a plurality of shared PLMNs available in the cell.

In step S41, the eNB send a reestablishment response, e.g. a RRCConnectionReestablishment message, which includes the newUE-Identity corresponding to the common RNTI that is used by joined devices to receive radio resource allocations for the D2D discovery, e.g. via PDCCH, from the selected shared PLMN. This message represents the grant for the D2D discovery.

According to further examples, the message in step S41 may also include a timer value or the like which is used for indicating how long the current registration to the D2D discovery (and/or communication) may last. That is, the time value may be used by the UE (and the eNB) for an implicit release of registration of the UE to the D2D discovery function.

In step S42, upon receiving the reestablishment message, i.e. the RRCConnectionReestablishment message, the UE responses with a corresponding reestablishment complete message, such as a RRCConnectionReestablishmentComplete message, which completes the message exchange of this procedure.

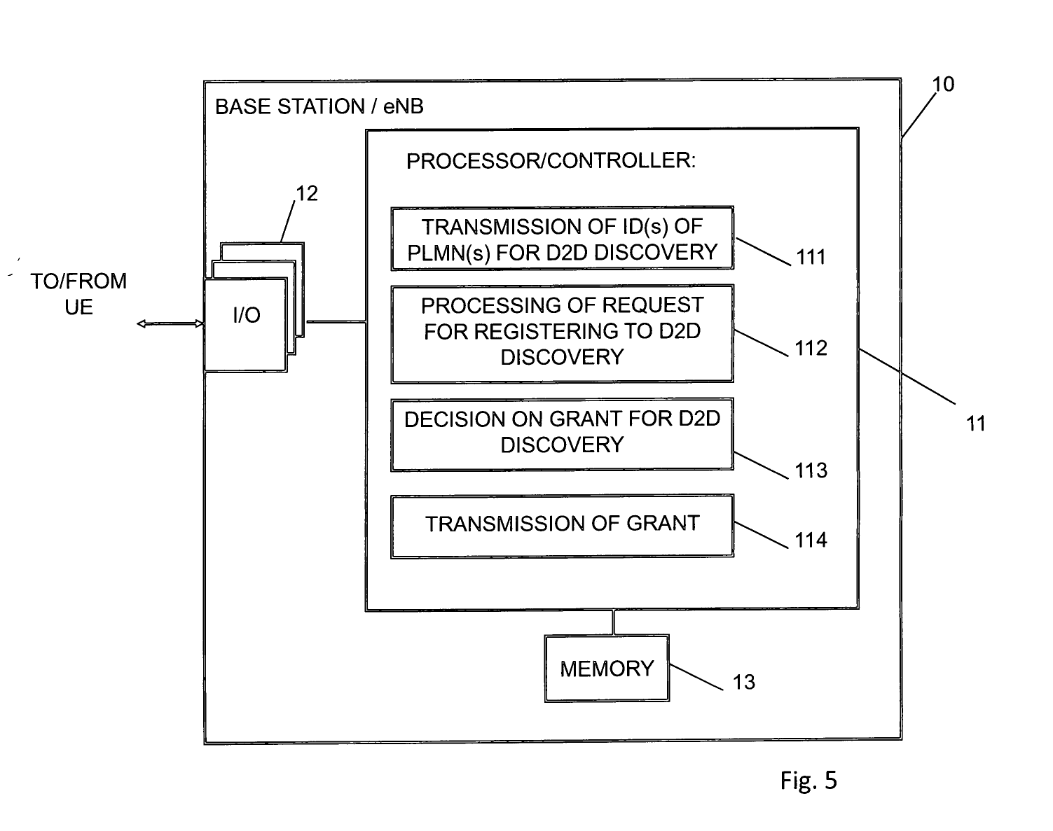

In FIG. 5, a block circuit diagram illustrating a configuration of a communication network control element, such as an eNB, is shown, which is configured to implement the processing for registering and attaching to a D2D discovery function as described in connection with the examples of embodiments of the invention. It is to be noted that the communication network control device or eNB 10 shown in FIG. 5 may comprise several further elements or functions besides those described herein below, which are omitted herein for the sake of simplicity as they are not essential for understanding the invention. Furthermore, even though reference is made to an eNB, the communication network element may be also another device having a similar function, such as a modem chipset, a chip, a module etc., which can also be part of a BS or attached as a separate element to a BS, or the like.

The communication network control element or eNB 10 may comprise a processing function or processor 11, such as a CPU or the like, which executes instructions given by programs or the like related to the D2D discovery registration control. The processor 11 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 12 denote transceiver or input/output (I/O) unit connected to the processor 11. The I/O unit 12 may be used for communicating with a communication network element like a UE. The I/O unit 12 may be a combined unit comprising communication equipment towards several network elements, or may comprise a distributed structure with a plurality of different interfaces for different network elements. Reference sign 13 denotes a memory usable, for example, for storing data and programs to be executed by the processor 11 and/or as a working storage of the processor 11.

The processor 11 is configured to execute processing related to the above described mechanism for registering and attaching to a D2D discovery function. In particular, the processor 11 comprises a sub-portion 111 as a processing portion which is usable as an identification transmission portion. The portion 111 may be configured to perform processing according to step S20 according to FIG. 2, for example. Furthermore, the processor 11 comprises a sub-portion 112 as a processing portion which is usable as a request receiving portion, which is able to receive and request the request for registering and attaching to the D2D function from a UE. The portion 112 may be configured, for example, to perform processing according to step S21 according to FIG. 2, for example. Moreover, the processor 11 comprises a sub-portion 113 as a processing portion which is usable as a granting processing portion for deciding on the grant for the D2D discovery. The portion 113 may be configured, for example, to perform a processing according to step S22 according to FIG. 2, for example. In addition, the processor 11 comprises a sub-portion 114 as a processing portion which is usable as a granting processing portion for send an indication of grant to the UE. The portion 114 may be configured, for example, to perform a processing according to step S23 according to FIG. 2, for example.

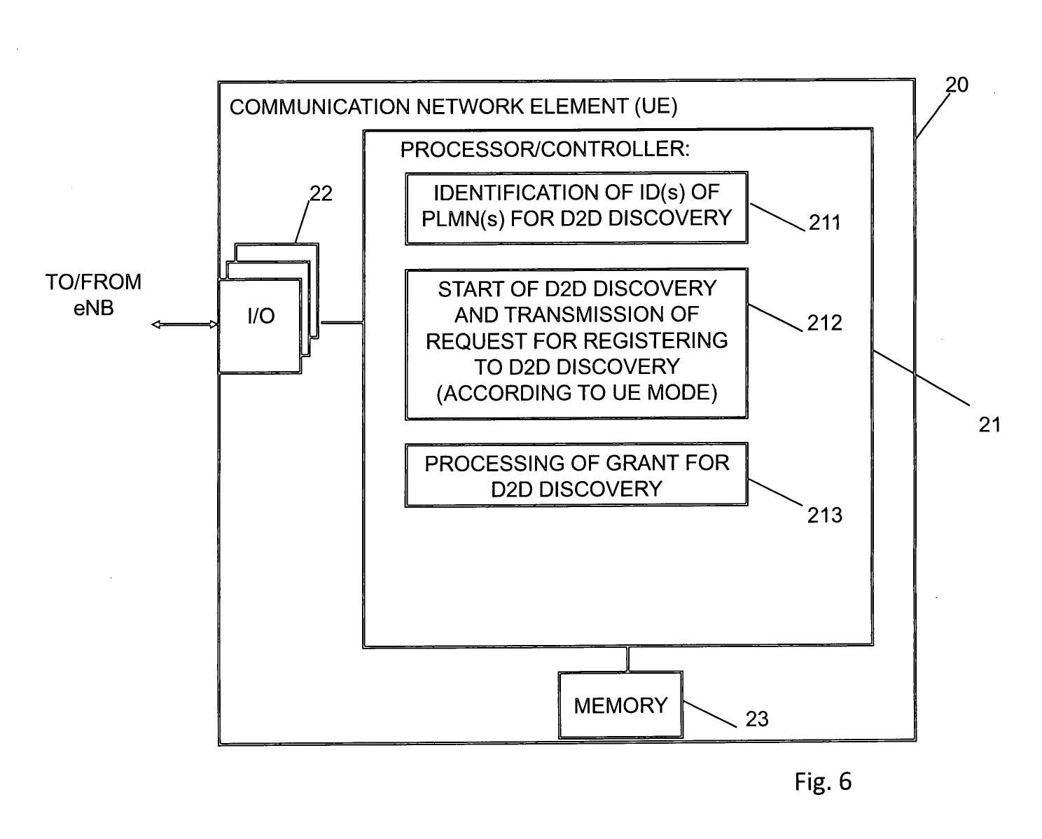

In FIG. 6, a block circuit diagram illustrating a configuration of a communication network element, such as of UE, is shown, which is configured to implement the processing as described in connection with the examples of embodiments of the invention, for example. It is to be noted that the communication network device or UE 20 shown in FIG. 6 may comprise several further elements or functions besides those described herein below, which are omitted herein for the sake of simplicity as they are not essential for understanding the invention. Furthermore, even though reference is made to a UE, the communication network element may be also another device having a similar function, such as a modem chipset, a chip, a module etc., which can also be part of a UE or attached as a separate element to a UE, or the like.

The communication network element or UE 20 may comprise a processing function or processor 21, such as a CPU or the like, which executes instructions given by programs or the like related to the D2D discovery registration control. The processor 21 may comprise one or more processing portions dedicated to specific processing as described below, or the processing may be run in a single processor. Portions for executing such specific processing may be also provided as discrete elements or within one or more further processors or processing portions, such as in one physical processor like a CPU or in several physical entities, for example. Reference sign 22 denotes transceiver or input/output (I/O) units connected to the processor 21. The I/O units 22 may be used for communicating with elements of the access network, such as a communication network control element like an eNB. The I/O units 22 may be a combined unit comprising communication equipment towards several of the network element in question, or may comprise a distributed structure with a plurality of different interfaces for each network element in question. Reference sign 23 denotes a memory usable, for example, for storing data and programs to be executed by the processor 21 and/or as a working storage of the processor 21.

The processor 21 is configured to execute processing related to the above described mechanism for registering and attaching to a D2D discovery function. In particular, the processor 21 comprises a sub-portion 211 as a processing portion which is usable as an identification processing portion. The portion 211 may be configured to perform processing according to step S10 according to FIG. 1, for example. Furthermore, the processor 21 comprises a sub-portion 212 as a processing portion which is usable as a request processing portion. The portion 212 may be configured to perform processing according to step S11 according to FIG. 1, for example. Moreover, the processor 21 comprises a sub-portion 213 as a processing portion which is usable as a response processing portion. The portion 213 may be configured to perform processing according to step S12 according to FIG. 1, for example.

It is to be noted that even though in the above examples of embodiments of the invention it is assumed that the shared PLMN identity is related to a own communication network of a separate operator, it is also possible to cover by means of this information element other types of networks. For example, operators may deploy so called femto eNBs or the like to the shared spectrum to improve the capacity in the network and to meet the requirements of increasing traffic in communication networks. It may be feasible from the capacity point of view to have certain shared spectrum for the eNB which can be used by different operators. Thus, the above described mechanism is also to be understood to be applicable to a scenario where several femto eNBs are present, in order to register a UE or the like into a serving system of the shared spectrum.

Furthermore, it is to be noted that the above described mechanism of registering and attaching a UE to a D2D discovery function is applicable in both cases of one operator and multiple operators.

As described above, examples of embodiments of the invention concerning the D2D discovery function registration mechanism are described to be implemented in UEs and eNBs. However, the invention is not limited to this. For example, examples of embodiments of the invention may be implemented in any wireless modems or the like.

According to further examples of embodiments of the invention, there is provided an apparatus comprising an identification processing means for receiving and identifying an identification information of at least one communication network assigned for a device-to-device discovery and communication, request processing means for sending a request for registering and attaching a communication network element to a device-to-device discovery function at the at least one communication network assigned for the device-to-device discovery and communication, and response processing means for receiving and processing a message indicating a grant for the device-to-device discovery, the message comprising an indication corresponding to an identity of the at least one communication network used for communicating resources dedicated to the device-to-device discovery and communication.

According to still further examples of embodiments of the invention, there is provided an apparatus comprising identification transmission means for sending an identification information of at least one communication network assigned for a device-to-device discovery and communication, request receiving means for receiving and processing a request for registering and attaching a communication network element to a device-to-device discovery function at the at least one communication network assigned for the device-to-device discovery and communication, and granting processing means for deciding on a grant for the device-to-device discovery and for sending a message indicating the grant for the device-to-device discovery, the message comprising an indication corresponding to an identity of the at least one communication network used for communicating resources dedicated to the device-to-device discovery and communication.

According to a further aspect A, examples of embodiments of the invention are related to a method comprising receiving and identifying an identification information of at least one communication network assigned for a device-to-device discovery and communication, sending a request for registering and attaching a communication network element to a device-to-device discovery function at the at least one communication network assigned for the device-to-device discovery and communication, and receiving and processing a message indicating a grant for the device-to-device discovery, the message comprising an indication corresponding to an identity of the at least one communication network used for communicating resources dedicated to the device-to-device discovery and communication.

According to a further aspect A1, in the method according to aspect A, the indication comprised in the message indicating the grant for the device-to-device discovery includes an identity allocated to the communication network element to be registered and attached to the device-to-device discovery function which corresponds to a temporary identity of the at least one communication network.

According to a further aspect A2, in the method according to aspect A, the identification information of the at least one communication network assigned for the device-to-device discovery and communication is received in a system information block as one of a part of a list of identities of communication networks sharing a same network access portion, and a separate data field comprised in the system information block.

According to a further aspect A3, in the method according to aspect A, there are further comprised including the identification information of the at least one communication network assigned for the device-to-device discovery and communication into the request for registering and attaching the communication network element to the device-to-device discovery function, and receiving and processing, as the message indicating the grant for the device-to-device discovery, the response message directed to the request comprising the identification information of the at least one communication network.

According to a further aspect A4, in the method according to aspect A, there are further comprised sending as the request for registering and attaching the communication network element to the device-to-device discovery function a connection establishing request message including a cause code indicating a device-to-device discovery as the cause for the connection establishing request, wherein, when a connection is setup in response to the connection establishing request, the at least one communication network assigned for the device-to-device discovery and communication is set as the communication network selected by the communication network element, and receiving and processing, as the message indicating the grant for the device-to-device discovery, a connection reconfiguration message comprising the indication corresponding to an identity of the at least one communication network used for communicating resources dedicated to the device-to-device discovery and communication.

According to a further aspect A5, in the method according to aspect A4, there is further comprised receiving with the connection reconfiguration message as the message indicating the grant for the device-to-device discovery a timer value indicating a time for which the registration for the device-to-device discovery is valid.

According to a further aspect A6, in the method according to aspect A4, there is further comprised conducting, when the connection is setup in response to the connection establishing request, an authentication and security activation, wherein the communication network element's own network is used for performing authentication.

According to a further aspect A7, in the method according to aspect A4, the communication network element is in an idle state.

According to a further aspect A8, in the method according to aspect A, there are further comprised sending as the request for registering and attaching the communication network element to the device-to-device discovery function a connection reestablishing request message including a cause code indicating a device-to-device discovery as the cause for the connection reestablishing request, and receiving and processing, as the message indicating the grant for the device-to-device discovery, a connection reestablishment message comprising the indication corresponding to an identity of the at least one communication network used for communicating resources dedicated to the device-to-device discovery and communication.

According to a further aspect A9, in the method according to aspect A8, there are further comprised including in the connection reestablishing request message as the request for registering and attaching the communication network element to the device-to-device discovery function a data field indicating the selected at least one communication network for the device-to-device discovery.

According to a further aspect A10, in the method according to aspect A8, there is further comprised receiving with the connection reestablishment message as the message indicating the grant for the device-to-device discovery a timer value indicating a time for which the registration for the device-to-device discovery is valid.

According to a further aspect A11, in the method according to aspect A8, the communication network element is in a connected state.

According to a further aspect B, examples of embodiments of the invention are related to a method comprising sending an identification information of at least one communication network assigned for a device-to-device discovery and communication, receiving and processing a request for registering and attaching a communication network element to a device-to-device discovery function at the at least one communication network assigned for the device-to-device discovery and communication, and deciding on a grant for the device-to-device discovery and sending a message indicating the grant for the device-to-device discovery, the message comprising an indication corresponding to an identity of the at least one communication network used for communicating resources dedicated to the device-to-device discovery and communication.

According to a further aspect B1, in the method according to aspect B, the indication comprised in the message indicating the grant for the device-to-device discovery includes an identity allocated to the communication network element to be registered and attached to the device-to-device discovery function which corresponds to a temporary identity of the at least one communication network.

According to a further aspect B2, in the method according to aspect B, there are further comprised sending the identification information of the at least one communication network assigned for the device-to-device discovery and communication in a system information block as one of a part of a list of identities of communication networks sharing a same network access portion, and a separate data field comprised in the system information block.

According to a further aspect B3, in the method according to aspect B, there are further comprised receiving and processing, in the request for registering and attaching the communication network element to the device-to-device discovery function, the identification information of the at least one communication network assigned for the device-to-device discovery and communication, and sending, as the message indicating the grant for the device-to-device discovery, a response message directed to the request comprising the identification information of the at least one communication network.

According to a further aspect B4, in the method according to aspect B, there are further comprised receiving and processing, as the request for registering and attaching the communication network element to the device-to-device discovery function, a connection establishing request message including a cause code indicating a device-to-device discovery as the cause for the connection establishing request, and, when a connection is setup in response to the connection establishing request, sending, as the message indicating the grant for the device-to-device discovery, a connection reconfiguration message comprising the indication corresponding to an identity of the at least one communication network used for communicating resources dedicated to the device-to-device discovery and communication.

According to a further aspect B5, in the method according to aspect B4, there is comprised sending with the connection reconfiguration message as the message indicating the grant for the device-to-device discovery a timer value indicating a time for which the registration for the device-to-device discovery is valid.

According to a further aspect B6, in the method according to aspect B4, there is further comprised conducting, when the connection is setup in response to the connection establishing request, an authentication and security activation, wherein the communication network element's own network is used for performing authentication.

According to a further aspect B7, in the method according to aspect B4, the communication network element is in an idle state.

According to a further aspect B8, in the method according to aspect B, there are further comprised receiving and processing, as the request for registering and attaching the communication network element to the device-to-device discovery function, a connection reestablishing request message including a cause code indicating a device-to-device discovery as the cause for the connection reestablishing request, and sending, as the message indicating the grant for the device-to-device discovery, a connection reestablishment message comprising the indication corresponding to an identity of the at least one communication network used for communicating resources dedicated to the device-to-device discovery and communication.

According to a further aspect B9, in the method according to aspect B8, there are further comprised receiving in the connection reestablishing request message as the request for registering and attaching the communication network element to the device-to-device discovery function a data field indicating the selected at least one communication network for the device-to-device discovery.

According to a further aspect B10, in the method according to aspect B8 there is further comprised sending with the connection reestablishment message as the message indicating the grant for the device-to-device discovery a timer value indicating a time for which the registration for the device-to-device discovery is valid.

According to a further aspect B11, in the method according to aspect B8, the communication network element is in a connected state.

According to a further aspect C, examples of embodiments of the invention are related to a computer program product for a computer, comprising software code portions for performing the steps of any of aspects A and A1 to A11 as well as any of aspects B and B to B11 when said product is run on the computer. The computer program product according to aspect C may comprise a computer-readable medium on which said software code portions are stored. Alternatively or additionally, the computer program product according to aspect C is directly loadable into the internal memory of the computer and/or transmittable via a network by means of at least one of upload, download and push procedures.

For the purpose of the present invention as described herein above, it should be noted that

an access technology via which signaling is transferred to and from a network element may be any technology by means of which a network element or sensor node can access another network element or node (e.g. via a base station or generally an access node). Any present or future technology, such as WLAN (Wireless Local Access Network), WiMAX (Worldwide Interoperability for Microwave Access), LTE, LTE-A, Bluetooth, Infrared, and the like may be used; although the above technologies are mostly wireless access technologies, e.g. in different radio spectra, access technology in the sense of the present invention implies also wired technologies, e.g. IP based access technologies like cable networks or fixed lines but also circuit switched access technologies; access technologies may be distinguishable in at least two categories or access domains such as packet switched and circuit switched, but the existence of more than two access domains does not impede the invention being applied thereto,
usable communication networks and transmission nodes may be or comprise any device, apparatus, unit or means by which a station, entity or other user equipment may connect to and/or utilize services offered by the access network; such services include, among others, data and/or (audio-) visual communication, data download etc.;
a user equipment or communication network element may be any device, apparatus, unit or means by which a system user or subscriber may experience services from an access network, such as a mobile phone, personal digital assistant PDA, or computer, or a device having a corresponding functionality, such as a modem chipset, a chip, a module etc., which can also be part of a UE or attached as a separate element to a UE, or the like;
method steps likely to be implemented as software code portions and being run using a processor at a network element or terminal (as examples of devices, apparatuses and/or modules thereof, or as examples of entities including apparatuses and/or modules for it), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, apparatuses, units or means likely to be implemented as hardware components at a terminal or network element, or any module(s) thereof, are hardware independent and can be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components; in addition, any method steps and/or devices, units or means likely to be implemented as software components may for example be based on any security architecture capable e.g. of authentication, authorization, keying and/or traffic protection;
devices, apparatuses, units or means can be implemented as individual devices, apparatuses, units or means, but this does not exclude that they are implemented in a distributed fashion throughout the system, as long as the functionality of the device, apparatus, unit or means is preserved; for example, for executing operations and functions according to examples of embodiments of the invention, one or more processors may be used or shared in the processing, or one or more processing sections or processing portions may be used and shared in the processing, wherein one physical processor or more than one physical processor may be used for implementing one or more processing portions dedicated to specific processing as described,
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

As described above, there is provided a mechanism for registering and attaching a UE to a D2D discovery function. After identifying an ID information of at least one PLMN assigned for a D2D discovery and communication, a request for registering and attaching the UE to the D2D discovery function at the identified PLNM is sent to the network. The network sends a grant for the D2D discovery together with an indication corresponding to an identity of the at least one PLMN used for communicating resources dedicated to the D2D discovery and communication.

Although the present invention has been described herein before with reference to particular embodiments thereof, the present invention is not limited thereto and various modifications can be made thereto.

1. An apparatus comprising
an identification processing portion configured to receive and identify an identification information of at least one communication network assigned for a device-to-device discovery and communication,
a request processing portion configured to send a request for registering and attaching a communication network element to a device-to-device discovery function at the at least one communication network assigned for the device-to-device discovery and communication, and
a response processing portion configured to receive and process a message indicating a grant for the device-to-device discovery, the message comprising an indication corresponding to an identity of the at least one communication network used for communicating resources dedicated to the device-to-device discovery and communication.

2. The apparatus according to claim 1, wherein the indication comprised in the message indicating the grant for the device-to-device discovery includes an identity allocated to the communication network element to be registered and attached to the device-to-device discovery function which corresponds to a temporary identity of the at least one communication network.

3. The apparatus according to claim 1, wherein the identification information of the at least one communication network assigned for the device-to-device discovery and communication is received in a system information block as one of
a part of a list of identities of communication networks sharing a same network access portion, and
a separate data field comprised in the system information block.

4. The apparatus according to claim 1, wherein
the request processing portion is configured to include the identification information of the at least one communication network assigned for the device-to-device discovery and communication into the request for registering and attaching the communication network element to the device-to-device discovery function, and
the response processing portion is configured to receive, as the message indicating the grant for the device-to-device discovery, the response message directed to the request comprising the identification information of the at least one communication network.

5. The apparatus according to claim 1, wherein
the request processing portion is configured to send as the request for registering and attaching the communication network element to the device-to-device discovery function a connection establishing request message including a cause code indicating a device-to-device discovery as the cause for the connection establishing request,
wherein, when a connection is setup in response to the connection establishing request, the at least one communication network assigned for the device-to-device discovery and communication is set as the communication network selected by the communication network element, and
the response processing portion is configured to receive, as the message indicating the grant for the device-to-device discovery, a connection reconfiguration message comprising the indication corresponding to an identity of the at least one communication network used for communicating resources dedicated to the device-to-device discovery and communication.

6. The apparatus according to claim 5, wherein the response processing portion is further configured to receive with the connection reconfiguration message as the message indicating the grant for the device-to-device discovery a timer value indicating a time for which the registration for the device-to-device discovery is valid.

7. The apparatus according to claim 5, further comprising
an authentication and security processing portion configured to conduct, when the connection is setup in response to the connection establishing request, an authentication and security activation, wherein the communication network element's own network is used for performing authentication.

8. The apparatus according to claim 5, wherein the communication network element is in an idle state.

9. The apparatus according to claim 1, wherein
the request processing portion is configured to send as the request for registering and attaching the communication network element to the device-to-device discovery function a connection reestablishing request message including a cause code indicating a device-to-device discovery as the cause for the connection reestablishing request, and
the response processing portion is configured to receive, as the message indicating the grant for the device-to-device discovery, a connection reestablishment message comprising the indication corresponding to an identity of the at least one communication network used for communicating resources dedicated to the device-to-device discovery and communication.

10. The apparatus according to claim 9, wherein the request processing portion is further configured to include in the connection reestablishing request message as the request for registering and attaching the communication network element to the device-to-device discovery function a data field indicating the selected at least one communication network for the device-to-device discovery.

11. The apparatus according to claim 9, wherein the response processing portion is further configured to receive with the connection reestablishment message as the message indicating the grant for the device-to-device discovery a timer value indicating a time for which the registration for the device-to-device discovery is valid.

12. The apparatus according to claim 9, wherein the communication network element is in a connected state.

13. An apparatus comprising
an identification transmission portion configured to send an identification information of at least one communication network assigned for a device-to-device discovery and communication,
a request receiving portion configured to receive and process a request for registering and attaching a communication network element to a device-to-device discovery function at the at least one communication network assigned for the device-to-device discovery and communication, and
a granting processing portion configured to decide on a grant for the device-to-device discovery and to send a message indicating the grant for the device-to-device discovery, the message comprising an indication corresponding to an identity of the at least one communication network used for communicating resources dedicated to the device-to-device discovery and communication.

14. The apparatus according to claim 13, wherein the indication comprised in the message indicating the grant for the device-to-device discovery includes an identity allocated to the communication network element to be registered and attached to the device-to-device discovery function which corresponds to a temporary identity of the at least one communication network.

15. The apparatus according to claim 13, wherein the identification transmission portion is configured to send the identification information of the at least one communication network assigned for the device-to-device discovery and communication in a system information block as one of
a part of a list of identities of communication networks sharing a same network access portion, and
a separate data field comprised in the system information block.

16. The apparatus according to claim 13, wherein
the request receiving portion is configured to receive, in the request for registering and attaching the communication network element to the device-to-device discovery function, the identification information of the at least one communication network assigned for the device-to-device discovery and communication, and
the granting processing portion is configured to send, as the message indicating the grant for the device-to-device discovery, a response message directed to the request comprising the identification information of the at least one communication network.

17. The apparatus according to claim 13, wherein
the request receiving portion is configured to receive, as the request for registering and attaching the communication network element to the device-to-device discovery function, a connection establishing request message including a cause code indicating a device-to-device discovery as the cause for the connection establishing request,
wherein, when a connection is setup in response to the connection establishing request, the granting processing portion is configured to send, as the message indicating the grant for the device-to-device discovery, a connection reconfiguration message comprising the indication corresponding to an identity of the at least one communication network used for communicating resources dedicated to the device-to-device discovery and communication.

18. The apparatus according to claim 17, wherein the granting processing portion is further configured to send with the connection reconfiguration message as the message indicating the grant for the device-to-device discovery a timer value indicating a time for which the registration for the device-to-device discovery is valid.

19. The apparatus according to claim 17, further comprising
an authentication and security processing portion configured to conduct, when the connection is setup in response to the connection establishing request, an authentication and security activation, wherein the communication network element's own network is used for performing authentication.

20. The apparatus according to claim 17, wherein the communication network element is in an idle state.

21. The apparatus according to claim 13, wherein
the request receiving portion is configured to receive, as the request for registering and attaching the communication network element to the device-to-device discovery function, a connection reestablishing request message including a cause code indicating a device-to-device discovery as the cause for the connection reestablishing request, and
the granting processing portion is configured to send, as the message indicating the grant for the device-to-device discovery, a connection reestablishment message comprising the indication corresponding to an identity of the at least one communication network used for communicating resources dedicated to the device-to-device discovery and communication.

22. The apparatus according to claim 21, wherein the request receiving portion is further configured to receive in the connection reestablishing request message as the request for registering and attaching the communication network element to the device-to-device discovery function a data field indicating the selected at least one communication network for the device-to-device discovery.

23. The apparatus according to claim 21, wherein the granting processing portion is further configured to send with the connection reestablishment message as the message indicating the grant for the device-to-device discovery a timer value indicating a time for which the registration for the device-to-device discovery is valid.

24. The apparatus according to claim 21, wherein the communication network element is in a connected state.

25. A method comprising
receiving and identifying an identification information of at least one communication network assigned for a device-to-device discovery and communication,
sending a request for registering and attaching a communication network element to a device-to-device discovery function at the at least one communication network assigned for the device-to-device discovery and communication, and
receiving and processing a message indicating a grant for the device-to-device discovery, the message comprising an indication corresponding to an identity of the at least one communication network used for communicating resources dedicated to the device-to-device discovery and communication.
